(19) United States
(12) Patent Application Publication
(10) Pub. No.: US 2011/0104481 A1
(43) Pub. Date: May 5, 2011

(54) Automatic toilet flush blocker

(76) Inventors: Sarah K. Day, Hillsboro, OR (US); Rebecca Marie Collett, Beaverton, OR (US)

(21) Appl. No.: 12/589,876

(22) Filed: Oct. 30, 2009

(51) Int. Cl. C09J 7/00

(52) U.S. Cl. 428/343

(57) ABSTRACT

A biodegradable paper cover that temporarily blocks the “eye” of a motion sensor on an automatic toilet providing complete flush control to the user: Motion sensor toilets often flush when it is not desirable, such as when a person is on it. This is especially true for young children because their stature does not block the sensor consistently. According to research, the unexpected flush is one of children's biggest fears. This can lead to refusal to use the toilet, high anxiety, or annoyance for any aged person. The blocker is placed over the “eye” to temporarily disable the automatic flush of the toilet. When the blocker is removed the toilet returns to normal functioning and flushes. The blocker is disposed of in the toilet where it dissolves. It eliminates the untimely flush, as well as the potential transfer of germs. The blocker provides complete flush control to the user.

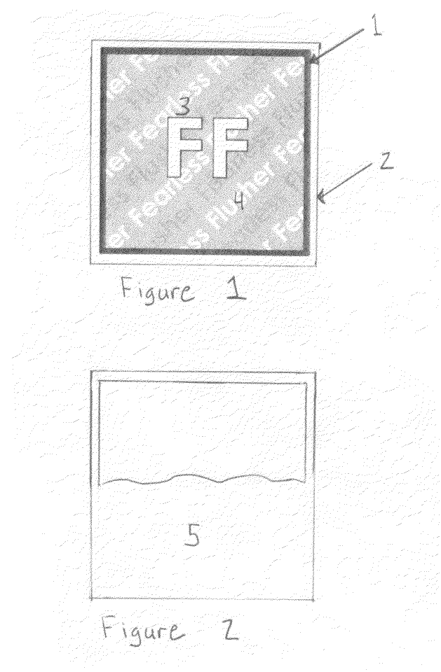

### CROSS-REFERENCE TO RELATED APPLICATIONS

NOT APPLICABLE

NOTE: Provisional Application on file:

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC

NOT APPLICABLE

### BACKGROUND OF INVENTION

### Statement of the Field of Endeavor to Which Invention Pertains:

The Automatic Toilet Flush Blocker pertains to the following fields: child psychology, toilet training/parent education, and bathroom sanitation.

### Subject Matter of Invention: (Classification: Toilet)

1. Toilet Training (CCL/4/902)
2. Actuator (CCL/4/405)

### Problems Involved in the Prior Art/Field Which Invention is Drawn Toward:

Motion sensor or automatic-flush toilets tend to be very intimidating to children, especially when they are potty training. Typically these toilets rely on a motion sensor which includes an electronic “eye” to determine when the toilet has been evacuated and is ready to be flushed. Generally, children by nature are too short for the electronic eye to detect when they are sitting on the toilet, therefore the toilet flushes while the child is still on it. The unexpected flush scares children and can hinder the progression of toilet training and may result in accidents and/or avoidance of public toilets. A similar product on the market is “the Flush-Stopper” is a permanent device designed to be reused. In comparison, the blocker is designed to be disposed of after each use to avoid the transference of unsanitary conditions from the public automatic toilet to the handler. These blockers are biodegradable and dissolve within seconds after being disposed of in the toilet.

### BRIEF SUMMARY OF THE INVENTION

A biodegradable, dissolvable, paper cover adhesive product which blocks the “eye” of motion sensor toilet preventing it from flushing. The unexpected flush of motion sensor/automatic toilets is one of the fastest growing fears of children. The blocker was designed to address this rapidly growing fear. Currently, there is one product available, which covers the “eye” of the motion sensor toilet. This product (The Flush-Stopper) is designed to be used multiple times by placing it back in its carrier and reusing it at a later time. The blocker is a disposable, biodegradable product that adheres to the motion sensor “eye” and after use is thrown into the toilet where it quickly dissolves. This eliminates the potential of transference of unsanitary conditions. Therefore, the blocker is a sanitary option giving complete flush control to the user.

### BRIEF DESCRIPTION OF THE SEVERAL VIEWS OF DRAWINGS

1. Automatic/motion sensor toilet.

2. Automatic toilet motion sensor “eye” (close up).

3. Automatic Toilet Flush Blocker is easily removed be pealing off paper backing (Fearless Flusher design-Graphic design may vary).

4. Blocker is placed over the “eye” on the automatic toilet.

5. The blocker covers the motion sensor “eye” on the automatic toilet, preventing toilet from flushing.

6. Removing blocker from “eye”: the blocker is easily removed by peeling a corner off the motion sensor “eye.”

7. Toilet flushing: once removed the toilet will flush.

8. Disposal of blocker: the blocker is placed in the toilet where it quickly dissolves.

### DETAILED DESCRIPTION OF THE INVENTION

### Explanation:

Motion sensor/automatic toilets, typically found in public settings, often flush when it is not desirable, such as when a person is approaching it or sitting on it. This is especially true for young children because their stature does not block the motion sensor “eye” consistently. To prevent the untimely flushing of automatic toilets, the Automatic Toilet Flush Blocker is placed over the toilet's motion sensor “eye.” The blocker temporarily prevents the toilet from flushing. The blocker is simply peeled off an adhesive backing (release liner), which is low tack so it is easy to pull off and placed over the “eye.” Once the occupant is finished with using the automatic toilet, the blocker is manually removed activating the toilet's flush. After use the blocker is then disposed of in the toilet where it quickly dissolves. Because it is disposable this eliminates the transfer of unsanitary conditions to personal belongings, children and self. Therefore, it eliminates the untimely flush, as well as the potential transfer of germs. The blocker provides complete flush control to the user.

### Process of Making:

1) The invention is comprised of a biodegradable adhesive paper and liner manufactured by Dissolvo. See Attachment A-D for information obtained from Dissolvo to describe their process, machine, composition and safety components, etc. of “Dissolvo Water-Soluble Purge Dams and Multi-Purpose Paper” used.
2) The “Dissolvo Water-Soluble Purge Dams and Multi-Purpose Paper” used were sent to a subsidiary company “Print My Thing” to size, print, cut and stack the material to the desired specifications.

### How to Use the Invention:

The product is comprised of the following steps:
1) The blocker is peeled off a release liner.
2) The adhesive side of the blocker is placed over the “eye” of the motion sensor of an automatic toilet.
3) After using the toilet the low tact blocker is easily removed by peeling it off the “eye” of the motion sensor. This then activates the flush mechanism of the toilet.
4) The blocker is disposed of in the toilet where it quickly dissolves.

1. The adhesive, biodegradable blocker is placed over the “eye” of a motion sensor toilet, blocking it temporarily from flushing.

2. When finished using the toilet, the blocker is peeled off the “eye” of the motion sensor. The removal of the blocker then allows the toilet to flush.

3. The blocker is disposed of in the toilet where it quickly dissolves.
